(19) United States
(12) Patent Application Publication
(10) Pub. No.: US 2008/0078340 A1
(43) Pub. Date: Apr. 3, 2008

(54) Fan Module motor mont arms with shape optimization

(75) Inventor: Brian Havel, London (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Canada Inc., Chatham (CA)

(21) Appl. No.: 11/892,847

(22) Filed: Aug. 28, 2007

Related U.S. Application Data
(60) Provisional application No. 60/827,268, filed on Sep. 28, 2006.

(51) Int. Cl. F01P 5/06; B29C 45/14; F04D 29/40

(52) U.S. Cl. 123/41.49; 165/51; 29/428; 415/213.1

(57) ABSTRACT

A fan module (10) for mounting a fan of a vehicle includes a base (12), a motor mount (14) constructed and arranged to mount a fan motor thereto, and a plurality of connecting elements (16) each having a radial axis and an axis generally transverse to the radial axis. Each connecting element extends radially between the base and the motor mount, coupling the motor mount to the base. At least one connecting element is oriented about the radial axis thereof in a manner different from an orientation of at least one other connecting element with respect to its radial axis so that the orientation of the at least one connecting element generally reduces interference with in-vehicle air flow patterns.

This application claims the benefit of the earlier filing date of U.S. Provisional Application No. 60/827,268, filed on Sep. 28, 2006, which is incorporated by reference herein in its entirety.

### FIELD OF THE INVENTION

This invention relates to fan modules for engine cooling of a vehicle and, more particularly, to the orientation and shape of the motor mounting or connecting elements of a shroud of fan module.

### BACKGROUND OF THE INVENTION

An electric motor drives a fan that moves air with the multiple fan blades. The typical blade configuration ensures that the blades extend from the root (fan hub) and stretch radially outward. The fan supplies the required air mass necessary for cooling of an engine of a vehicle. The electric motor drive must be mounted to a fix point relative to the vehicle in the engine compartment. If there is ample space for installation of a fan module in the engine compartment, then a multiplicity of guide vane elements or motor mounting elements are used which can be formed to minimize noise. If the available space in the engine compartment is tight which is typically becoming more common, the electric motor drive is often mounted into the position of the fan opening using a few, thick radial or tangential elements. These connecting elements maintain structural rigidity but create an obstacle to the air path produced by the fan. These obstacles in the path of the airflow then create an acoustic disturbance that leads to a noise generally perceived as unpleasant. In addition, the airflow in the engine compartment is highly un-symmetric in the tangential direction because several engine accessory components block the inlet and outlet air path to the fan.

With reference to FIG. 1, a cross-section of a conventional tangential element 10 of a shroud is shown having a generally U-Shape. An air flow velocity vector V (the resultant of the tangential and axial air flow velocity vectors) is shown approaching the element 100 and an air flow pattern caused by the element 100 is shown by the thin arrow lines in FIG. 1. As can be seen, there is high flow interference due to the shape of the element 100. This U-shape provides excellent structural performance; however, the shape is acoustically detrimental.

A cross-section of conventional “thin” tangential element 100′ of a shroud is shown in FIG. 2. The air flow velocity vector V is shown approaching the element 100′ and an air flow pattern caused by the element 100′ is shown by the thin arrow lines in FIG. 2. There is low flow interference due to the shape of the element 100′. However, the shape of the element 10 provides weak structural performance.

Thus, there is a need to provide a fan module that optimizes aerodynamics and structural performance in tight spaced areas of engine compartments and that provides lower tonal content noise performance that is perceived as more pleasant psychoacoustics.

### SUMMARY OF THE INVENTION

An object of the invention is to fulfill the need referred to above. In accordance with the principles of the present invention, this objective is achieved by providing a fan module for mounting a fan of a vehicle. The fan module includes a base, a motor mount constructed and arranged to mount a fan motor thereto, and a plurality of connecting elements each having a radial axis and an axis generally transverse to the radial axis. Each connecting element extends radially between the base and the motor mount, coupling the motor mount to the base. At least one connecting element is oriented about the radial axis thereof in a manner different from an orientation of at least one other connecting element with respect to its radial axis so that the orientation of the at least one connecting element generally reduces interference with in-vehicle air flow patterns.

In accordance with another aspect of the invention, a method provides a module for mounting a fan of a vehicle. The method provides a base and a motor constructed and arranged to mount a fan motor thereto. A plurality of connecting elements is provided, each having a radial axis and an axis generally transverse to the radial axis. Each connecting element extends radially between the base and the motor mount, coupling the motor mount to the base. The method determines an average velocity vector of airflow that will approach each of the connecting elements. The method ensures that each connecting element is oriented about the radial axis thereof such that the transverse axis thereof is generally parallel with respect to the average velocity vector so that the orientation of each connecting element generally reduces interference with in-vehicle air flow patterns.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a sectional view of a conventional U-shaped tangential element of a shroud.

FIG. 2 is a sectional view of a conventional thin tangential element of a shroud.

FIG. 3 shows a fan module having motor mount arms or connecting elements provided in accordance with an embodiment of the present invention.

FIG. 4 shows a portion of a connecting element of FIG. 3 and axes thereof.

FIG. 5 shows a cross section of the connecting element of FIG. 4.

FIG. 6 is a sectional view of a connecting element of another embodiment of the invention shown in an air flow path.

FIG. 7 is a plan view of a portion of the fan module in accordance with another embodiment of the invention.

FIG. 8 is a view of a connecting element as viewed from the line 8-8 of FIG. 7.

FIG. 9A is a sectional view taken along the line 9A-9A in FIG. 8.

FIG. 9B is a sectional view taken along the line 9B-9B in FIG. 8.

FIG. 9C is a sectional view taken along the line 8C-8C in FIG. 8.

FIG. 10 is a view of a connecting element as viewed from the line 10-10 of FIG. 7.

FIG. 11A is a sectional view taken along the line 11A-11A in FIG. 10.

FIG. 11B is a sectional view taken along the line 11B-11B in FIG. 10.

FIG. 11C is a sectional view taken along the line 11C-11C in FIG. 10.

### DETAILED DESCRIPTION OF THE EXEMPLARY EMBODIMENTS

A fan has the purpose to move a substance of gaseous state. A multiple number of fan blades fixed rigidly to a fan hub and surrounded by a ring produces air flow when rotating. The fan produces air at very high flow rates even when the wake of the fan is highly restricted by obstacles. Therefore, such a fan is highly suited for automotive engine cooling applications where the wake of the fan is blocked by the automotive engine or other components.

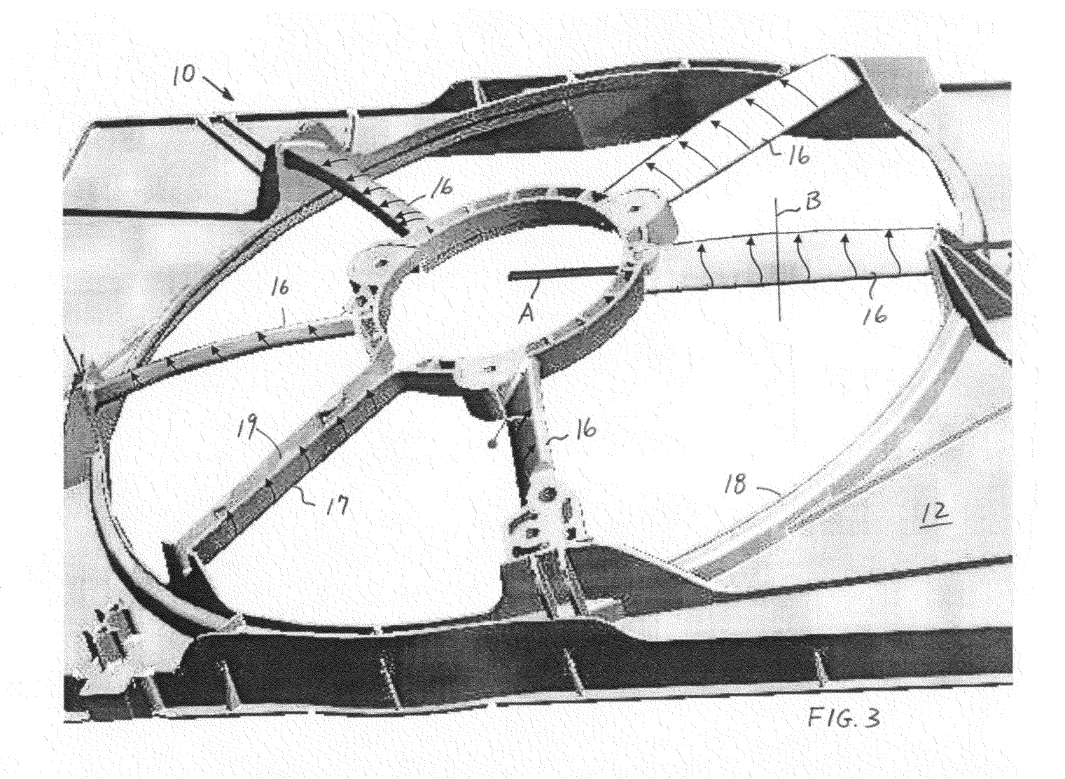

The fan is coupled to a shaft of a motor. The motor (not shown) is mounted to a fan module or shroud 10 (FIG. 3). The module 10 includes a generally rectangular base 12, a motor mount 14, for mounting the motor thereto, and a plurality of motor mount arms or connecting elements 16 connecting the motor mount 14 to the base 12. The base 12 includes an opening for receiving a fan (not shown) in the conventional manner. A member 17 between the base 12 and motor mount 14 includes a trough 19 for receiving the wires for powering the motor. Each connecting element 16 has a radial axis A and an axis B generally transverse with respect to axis A.

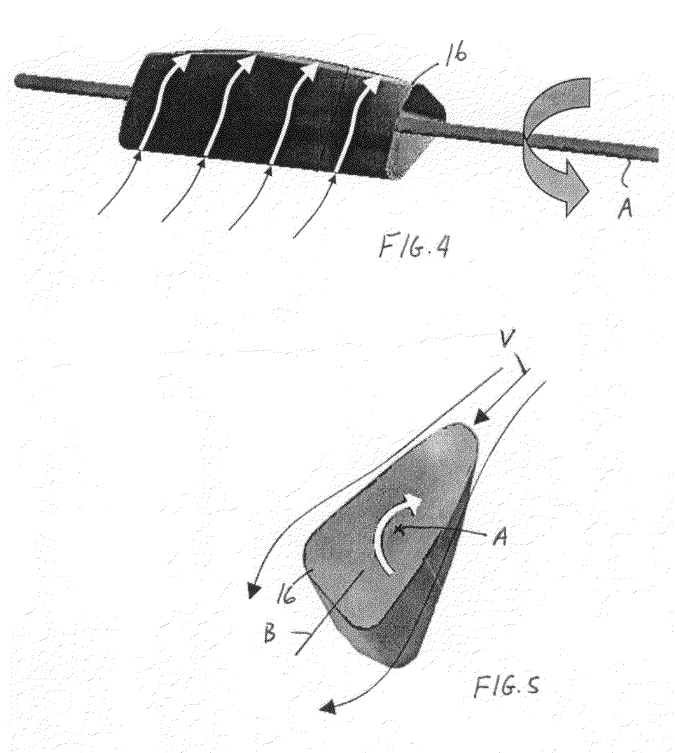

With reference to FIGS. 3-5 the geometry of the connecting elements 16 is adapted to the spiral-shaped air path in the wake of a fan, such that the aerodynamic disturbance is reduced and the connecting elements 16 pose a nearly neutral acoustic effect. The arrows in FIG. 3 show the air flow direction. As shown in FIG. 5, each connecting element 16 of the embodiment of FIGS. 3 and 4 is generally triangular in section and is solid. However, to reduce material and ensuring good plastic flow during molding, cavities (not shown) can be provided in an underside of the element 16.

In a vehicle, air velocity is not symmetric due to blockage of various underhood components and upstream parts such as the bumper, unequal radiator resistance, etc. Thus, the connecting elements 16 are also adapted to the vehicle geometry such that the elements 16 are adjusted to the air flow according to their tangential positions to generally reduce interference with in-vehicle air flow patterns or match in-vehicle velocity conditions. Each connecting element 16 is oriented (rotated) about a radial axis A (FIG. 5) thereof in a manner different from an orientation of at least one other connecting element 16 with respect to its radial axis. In the embodiment, each connecting element 16 is oriented differently with respect to each other connecting element 16. Thus, the connecting elements 16 around the electric motor drive can be non-identically oriented and adapted to the un-symmetric flow.

With reference to FIG. 6, the main angle of orientation θ of the connection elements 16 aligns with the average oncoming air flow velocity vector V. In other words, axis B is generally parallel to V. To determine the oncoming flow angle θ for each connecting element 16, the velocity vector V is either measured or simulated using computational fluid dynamics.

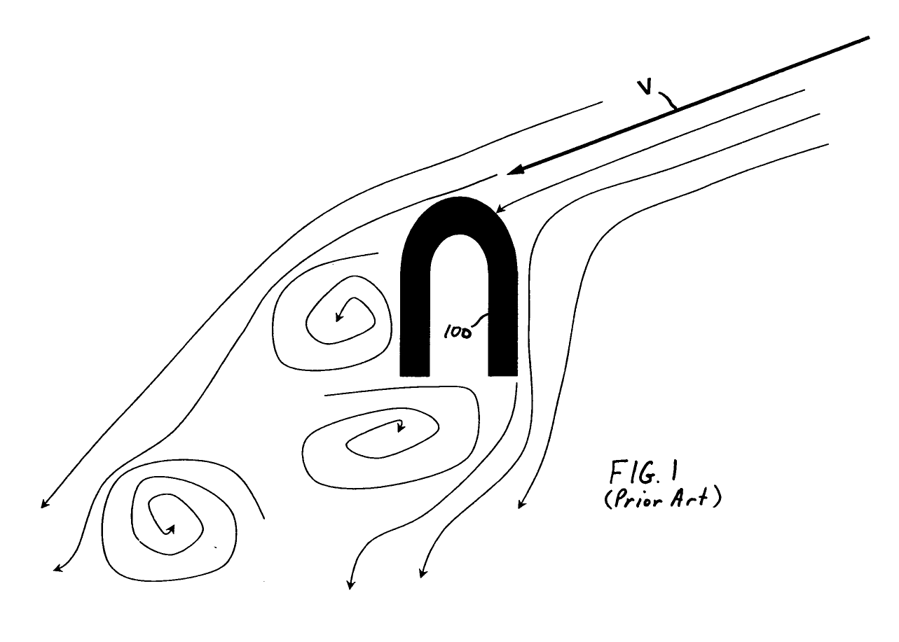

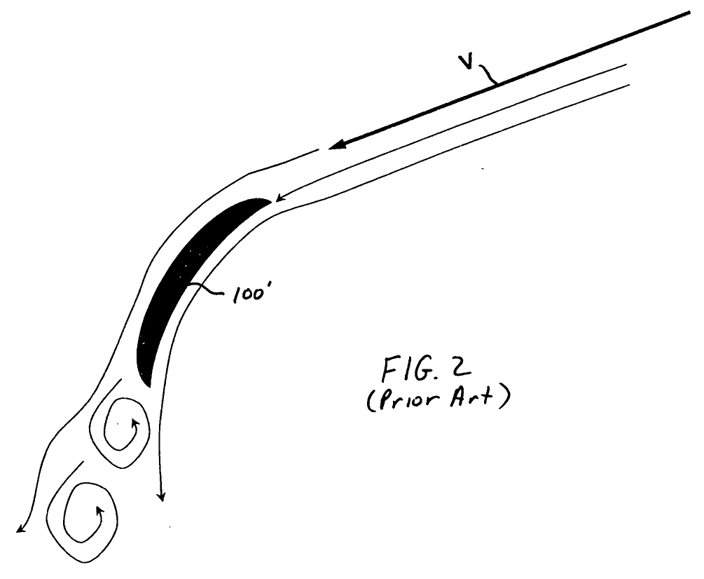

The shape of the connecting element 16 of FIG. 5 fulfills three major functions: aerodynamic, acoustic, and structural (rigidity) performance. However, a disadvantage of the solid shape of the connecting element 16 is that is expensive to manufacture because it needs high pressure in the plastic injection molding process. Thus, FIG. 6 shows a section of another embodiment of a connecting element 16″ that can be molded with reduced pressure in the plastic injection molding process. This is possible since the connecting element 16″ is generally a non-symmetrical elliptical shape having cavities 20 therein to reduce material. Furthermore, when injected out of plastic, there is a maximum allowable thickness to the element. If the element is fully solid (as in FIG. 5), the plastic may not fill properly during injection. Providing the cavities 20 permits proper plastic filling and has been found not to deteriorate the acoustic, aerodynamic or structural performance of the connecting element 16″. The connecting element 16″ has a height h and a width w of maximum values defined by the U-shaped elements 100 of FIG. 1.

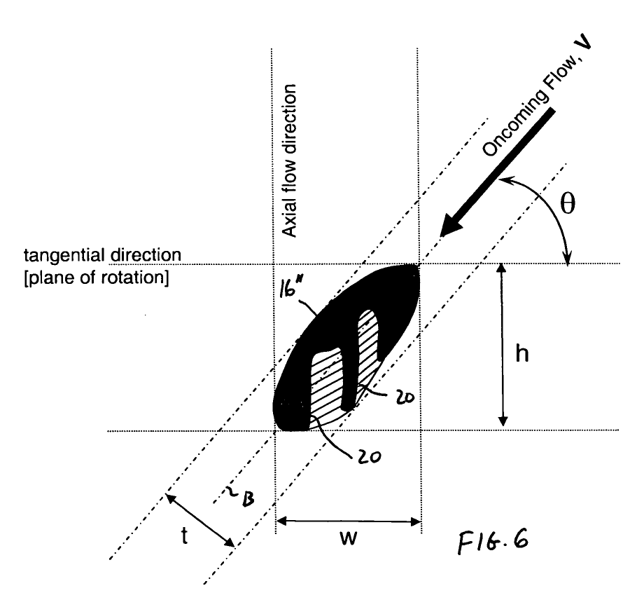

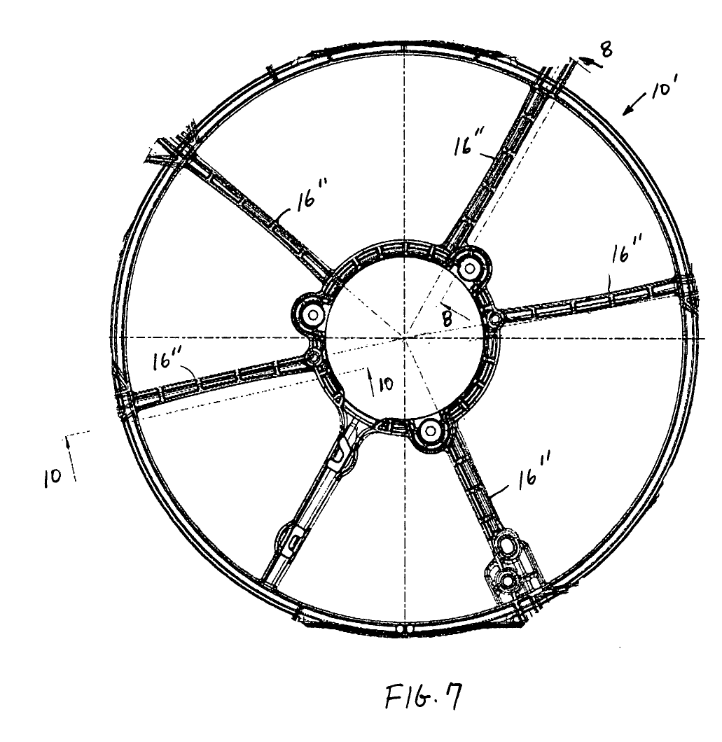

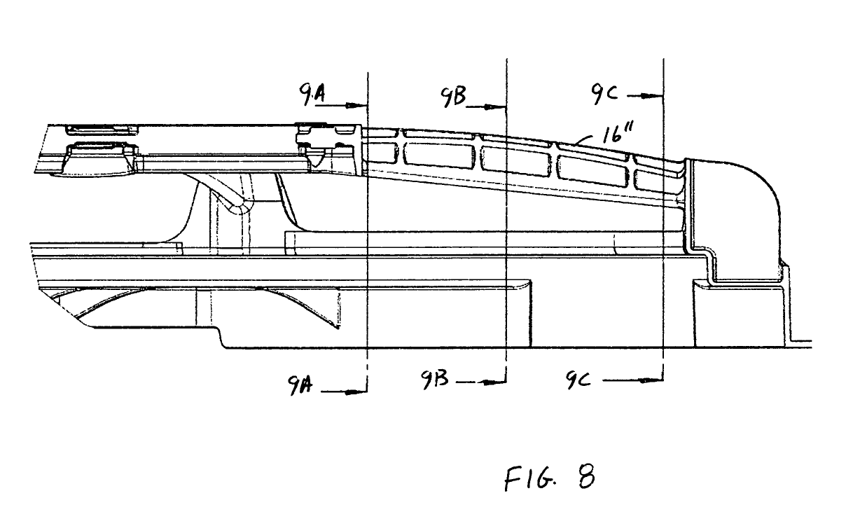

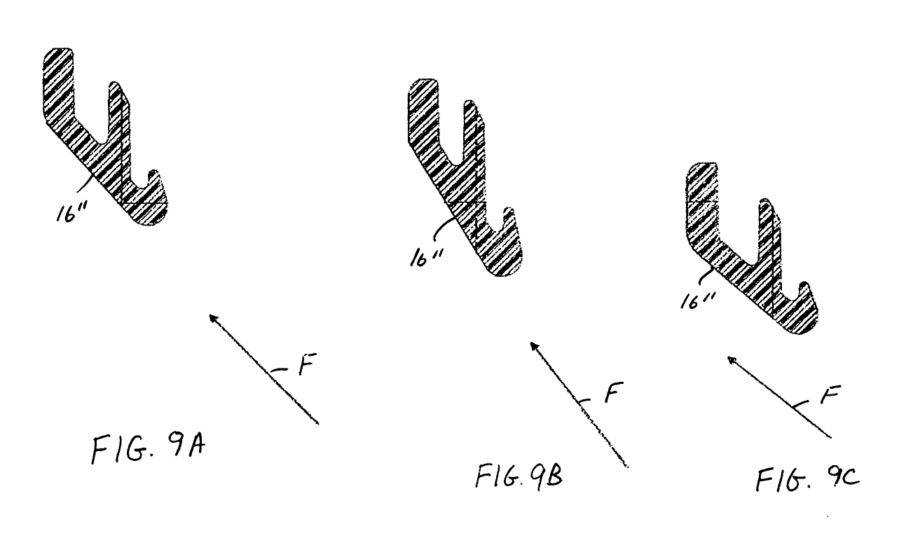

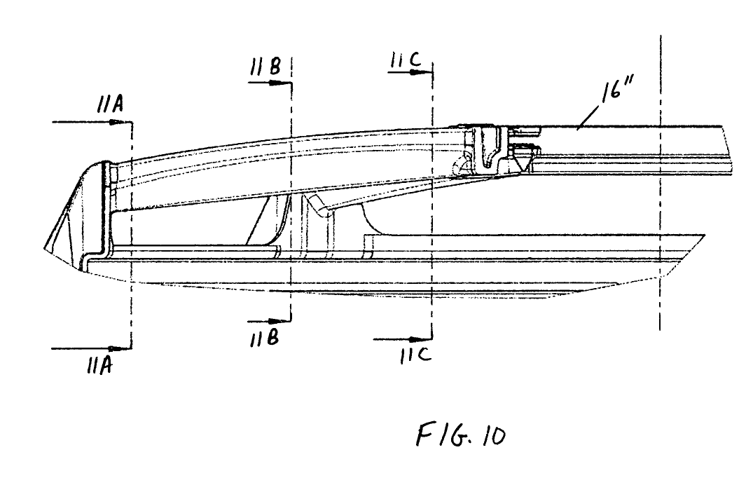

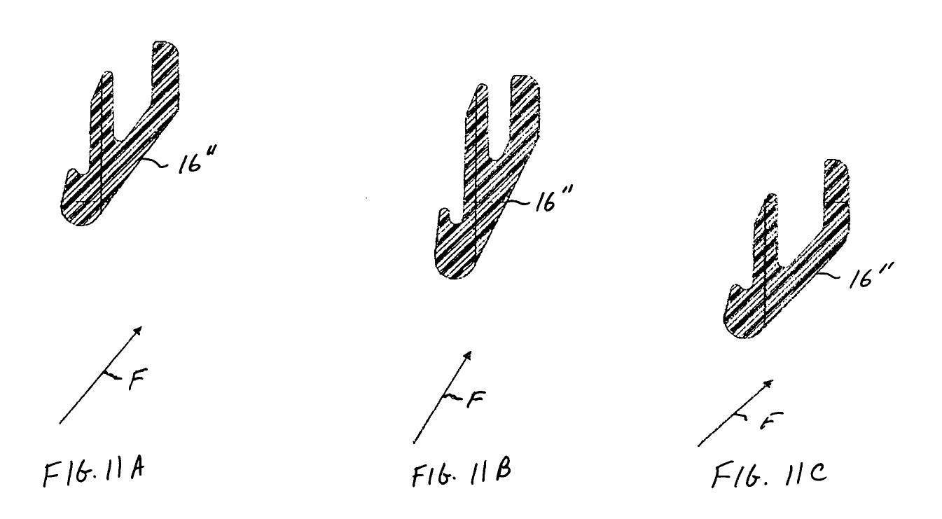

FIG. 7 shows a plan view of a portion of a fan module 10′ in accordance with another embodiment of the invention. In accordance with the embodiment, and with reference to FIGS. 7, 8, 9A, 9B, 9C, 10, 11A, 11B and 11C, as a function of their radial position, the shape of each connecting element 16″ changes to reflect the prevalent flow condition so as to be aerodynamically as well as structurally optimized. The air flow direction is indicated by arrows F in FIGS. 8A, 8B, 8C and 11A, 11B and 11C. Aerodynamically, the connecting elements 16′ should be as thin as possible to reduce interference with air; however, thin parts reduce the structural stability and can cause breakage of the part. Thus, an optimized configuration is preferable. Furthermore, the configuration of the connecting elements must be manufacturable, preferably made using an “off-the-shelf” state-of-art-linear injection tool.

Thus, the fan module 10, 10′ of the embodiment when employed with a fan (not shown) minimizes the acoustic disturbance associated with the installation of fan modules in tight, complicated engine compartments with the connecting elements 16, 16″ providing structural integrity.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A fan module for mounting a fan of a vehicle, the module comprising:
a base,
a motor mount constructed and arranged to mount a fan motor thereto, and
a plurality of connecting elements each having a radial axis and an axis generally transverse to the radial axis, each connecting element extending radially between the base and the motor mount, coupling the motor mount to the base, at least one connecting element being oriented about the radial axis thereof in a manner different from an orientation of at least one other connecting element with respect to its radial axis so that the orientation of the at least one connecting element generally reduces interference with in-vehicle air flow patterns.

2. The module of claim 1, wherein each connecting element has a cross-section that varies as a function of radial position thereof.

3. The module of claim 2, wherein the cross-section of each connecting element is generally triangular.

4. The module of claim 3, wherein each connecting element is solid.

5. The module of claim 3, wherein each connecting element is oriented such that the transverse axis thereof is generally parallel with respect to an average oncoming air flow velocity vector.

6. The module of claim 2, wherein the cross-section of each connecting element is generally of non-symmetrical elliptical shape having at least one cut-out therein.

7. The module of claim 6, wherein each connecting element is oriented such that the transverse axis thereof is generally parallel with respect to an average oncoming air flow velocity vector.

8. The module of claim 1, wherein each connecting element is oriented about its radial axis thereof in a manner different from each other connecting element so that the orientation of each connecting element generally reduces interference with in-vehicle air flow patterns.

9. The module of claim 1, wherein one of the connecting elements includes a trough constructed and arranged to receive wire for powering a motor.

10. A fan module for mounting a fan of a vehicle, the module comprising:
a base,
a motor mount constructed and arranged to mount a fan motor thereto, and
a plurality of connecting elements each having a radial axis and an axis generally transverse to the radial axis, each connecting element extending radially between the base and the motor mount, coupling the motor mount to the base, each connecting element being oriented about the radial axis thereof in a manner different from an orientation of each other connecting element with respect to the associated radial axis thereof so that the orientation of each connecting element generally reduces interference with in-vehicle air flow patterns,
wherein each connecting element has a cross-section that varies as a function of radial position thereof.

11. The module of claim 10, wherein the cross-section of each connecting element is generally triangular.

12. The module of claim 11, wherein each connecting element is solid.

13. The module of claim 11, wherein each connecting element is oriented such that the transverse axis thereof is generally parallel with respect to an average oncoming air flow velocity vector.

14. The module of claim 11, wherein the cross-section of each connecting element is generally of non-symmetrical elliptical shape having at least one cut-out therein.

15. The module of claim 14, wherein each connecting element is oriented such that the transverse axis thereof is generally parallel with respect to an average oncoming air flow velocity vector.

16. The module of claim 10, wherein one of the connecting elements includes a trough constructed and arranged to receive wire for powering a motor.

17. A method of providing a fan module for mounting a fan of a vehicle, the method including:
providing a base and a motor constructed and arranged to mount a fan motor thereto,
providing a plurality of connecting elements each having a radial axis and an axis generally transverse to the radial axis, each connecting element extending radially between the base and the motor mount, coupling the motor mount to the base,
determining an average velocity vector of airflow that will approach each of the connecting elements, and
ensuring that each connecting element is oriented about the radial axis thereof such that the transverse axis thereof is generally parallel with respect to the average velocity vector so that the orientation of each connecting element generally reduces interference with in-vehicle air flow patterns.

18. The method of claim 17, wherein the step of providing the plurality of connecting elements includes ensuring that each connecting element has a cross-section that varies as a function of radial position thereof.

19. The method of claim 17, wherein the step of providing the plurality of connecting elements includes ensuring that a cross-section of each connecting element is generally of non-symmetrical elliptical shape having at least one cut-out therein.

20. The method of claim 17, wherein the step of providing the plurality of connecting elements includes ensuring that a cross-section of each connecting element is generally triangular and substantially solid.
